(19) United States
(12) Patent Application Publication
(10) Pub. No.: US 2009/0102880 A1
(43) Pub. Date: Apr. 23, 2009

(54) Liquid Storing Container

(75) Inventor: Hitotoshi KIMURA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/255,532

(22) Filed: Oct. 21, 2008

(30) Foreign Application Priority Data
Oct. 23, 2007 (JP) 2007-274739
Aug. 28, 2008 (JP) 2008-219263

(51) Int. Cl. B41J 2/175

(52) U.S. Cl. 347/19; 347/86

(57) ABSTRACT

Provided is a liquid storing container including: a liquid containing unit which discharges a liquid by introducing a pressurized fluid into a region, in which the liquid is received; a liquid lead-out port which supplies the liquid from the liquid containing unit to a liquid consumption device; and a detecting device which is provided between the liquid containing unit and the liquid lead-out port, wherein the detecting device includes a liquid storing unit which is provided between the liquid containing unit and the liquid lead-out port; a piezoelectric element which applies vibration to a sensor cavity for containing the liquid in communication with the liquid storing unit and detects a state of free vibration due to the vibration; and a movement member which is displaced according to a pressurized state of the liquid storing unit at a position facing the sensor cavity.

### BACKGROUND

1. Technical Field

The present invention relates a liquid storing container suitable for detecting an ink residual quantity or detecting a pressurized/unpressurized state in an ink. cartridge.

2. Related Art

An ink cartridge having an ink residual quantity detecting function is disclosed in JP-A-2006-160371. The ink residual quantity is detected by providing a movement member, which moves according to a liquid surface level, in an ink storing unit, applying vibration to a concave portion (sensor cavity) which forms a closed space in cooperation with a wall surface of the movement member by a piezoelectric element and detecting the state of free vibrations.

In JP-A-2006-160371, a deformable ink pack is provided in a casing of the ink cartridge on the upstream side of the ink storing unit. A pressurized fluid, for example, air is introduced into the vicinity of the ink pack provided in the casing of the ink cartridge, the ink pack is pressurized by the air, and the ink in the ink pack is discharged. Accordingly, if the ink residual quantity of the ink pack is reduced, the ink pressure applied from the ink pack to the liquid storing unit is also reduced.

As the detection of the ink residual quantity, the movement member which is displaced according to the liquid pressure of the ink storing unit is provided and the ink end is detected on the basis of the output from the piezoelectric element when the sensor cavity becomes the closed space by the movement member by reducing the liquid pressure from the ink pack.

Meanwhile, as a method of supplying an ink of an ink cartridge, a method of directly supplying air into the inside of an ink containing unit is considered. In such an ink cartridge, an ink detecting device needs to be mounted, but, if the ink containing unit of this method and the ink residual quantity detecting function of JP-A-2006-160371 are combined, an air pressure continuously acts on the ink storing unit instead of the ink pressure if the pressurization due to air is continued although the ink of the ink containing unit runs out. Accordingly, since the movement member of the ink storing unit is not displaced, the method of detecting the ink end according to the position of the movement member cannot be employed.

As another pressurizing method, the ink cartridge is used as a sub tank and is used in combination with a high-capacity main tank connected to the sub tank. In this case, by the ink pressure applied from the main tank, the ink pressurized and supplied from the ink cartridge which is the sub tank. Even in the ink cartridge which is the sub tank, the detection of a pressurized/unpressurized state of the ink is required as described above.

### SUMMARY

An advantage of some aspects of the invention is that it provides a liquid storing container capable of detecting a pressurized/unpressurized state to a liquid containing region or detecting a liquid residual quantity even when a pressurizing method of introducing a pressurized fluid into the liquid containing region is employed.

According to an aspect of the invention, there is provided a liquid storing container including: a liquid containing unit which discharges a liquid by introducing a pressurized fluid into a region, in which the liquid is stored; a liquid lead-out port which supplies the liquid from the liquid containing unit to a liquid consumption device; and a detecting device which is provided between the liquid containing unit and the liquid lead-out port, wherein the detecting device includes a liquid storing unit which is provided between the liquid containing unit and the liquid lead-out port; a piezoelectric element which applies vibration to a sensor cavity for receiving the liquid in communication with the liquid storing unit and detects a state of free vibration due to the vibration; and a movement member which is displaced according to a pressurized state of the liquid storing unit at a position facing the sensor cavity.

In the aspect of the invention, the liquid from the liquid containing unit is pressurized and discharged by introducing the pressurized fluid into the region in which the liquid of the liquid containing unit is received. Accordingly, after all the liquid in the liquid containing unit is discharged to the liquid storing unit, the pressurized fluid is introduced from the liquid containing unit to the liquid storing unit, which is different from JP-A-2006-160371. If the liquid is introduced from the liquid containing unit to the movement member disposed in the liquid storing unit and the pressurized fluid is introduced from the liquid containing unit by the liquid pressure, the pressurized fluid pressure is applied. Accordingly, if the liquid containing unit is pressurized, the movement member is separated from the sensor cavity and is not displaced even when the pressure is changed from the liquid pressure to the fluid pressure, which is different from JP-A-2006-160371. If the liquid containing unit is not pressurized, the movement member is displaced to a position of the sensor cavity side which is different from the above-described position.

In the aspect of the invention, by the piezoelectric element which applies the vibration to the sensor cavity for containing the liquid in communication with the liquid storing unit and becomes the state of the free vibration due to the vibration, it is possible to detect the liquid residual quantity on the basis of a difference in the pressurized medium regardless of the movement member or detect the pressurized state or the unpressurized state on the basis of the position of the movement member.

For example, the pressurized fluid is different from the liquid to be tested. In this case, the piezoelectric element outputs different signals depending on whether or not a medium between the sensor cavity and the movement member is the liquid, at the time of pressurizing the liquid containing unit. The different signals are frequencies of free vibration or amplitudes of free vibration. One surface of the movement member may close the sensor cavity at the time of unpressurizing the liquid containing unit. In this case, the piezoelectric element may output the different signals at the time of pressuring and unpressurizing the liquid containing unit. The different signals are frequencies of free vibration or amplitudes of free vibration. The pressurization and the unpressurization of the liquid containing unit may be detected on the basis of a combination of the frequencies and amplitudes of the free vibration output from the piezoelectric element.

If the pressurized fluid is different from the liquid to be tested, the liquid residual quantity can be detected by the medium acting on the movement member and the pressurized/unpressurized state can be detected on the basis of the displacement of the movement member. In this case, the representative example of the pressurized fluid is air.

In another aspect of the invention, the pressurized fluid may be the liquid to be tested. In this example, for example, an ink cartridge is used as a sub tank and is used together with a high-capacity main tank connected to the sub tank. In this case, the ink is pressurized and supplied from the ink cartridge which is the sub tank, by the ink pressure supplied from the main tank.

Even in this case, one surface of the movement member closes the sensor cavity at the time of unpressurizing the liquid containing unit, and the piezoelectric element outputs different signals at the time of pressurizing and unpressurizing the liquid containing unit. Accordingly, it is possible to detect the pressurized/unpressurized state of the liquid containing unit of the ink cartridge used as the sub tank. The different signals are the amplitudes of the free vibration. The pressurization and the unpressurization of the liquid containing unit may be detected on the basis of a combination of the frequencies and amplitudes of the free vibration output from the piezoelectric element.

In the aspect of the invention, the liquid storing unit may be configured by sealing an opening formed in the upper surface thereof by a film which is deformable according to the pressurized state, and the piezoelectric element may be disposed below the liquid storing unit.

Accordingly, the liquid storing unit is deformed by the film deformed according to the pressure of the liquid or the pressurized fluid in the liquid storing unit, a liquid-tight space can be readily formed by the film, and liquid leakage or liquid evaporation can be prevented by a simple structure, compared with mechanical seal.

In the aspect of the invention, the movement member may be moved by the deformation of the film corresponding to the variation in pressurized state of the liquid storing unit and the movement member may be preferably adhered to the film.

Accordingly, since the movement member is displaced by the pressurization/unpressurization, the output waveform of the piezoelectric element can vary and the pressurized/unpressurized state can be detected.

In the aspect of the invention, the movement member may be urged by an urging member in a direction in which the piezoelectric element is disposed.

By adjusting the urging force of the urging member, a time point when the movement member is displaced and the displacement amount are adjusted in correspondence with a variation in pressurizing force such that the pressurized/unpressurized state can be detected with certainty.

### BRIEF DESCRIPTION OF THE DRAWINGS

The invention will be described with reference to the accompanying drawings, wherein like numbers reference like elements.

FIGS. 1A to 1C are views explaining the principle of the invention.

FIGS. 2A to 2C are views showing output waveforms corresponding to FIGS. 1A to 1C.

FIG. 3 is a view showing an example of an ink cartridge according to the invention.

FIG. 4 is a view showing another example of an ink cartridge according to the invention.

FIG. 5 is a perspective view of a printer according to an embodiment of the invention.

FIG. 6 is an exploded perspective view of the printer shown in FIG. 5.

FIG. 7 is an exploded perspective view of a liquid detecting unit.

FIGS. 8A and 8D are schematic perspective views of a casing main body of the liquid detecting unit.

FIG. 9 is a perspective view of a sensor base when viewed from the back.

FIG. 10 is a perspective view of the sensor base in which a sensor chip is mounted, when viewed from the front.

FIG. 11 is a plan view of an ink storing unit.

FIG. 12 is a cross-sectional view taken along a Y axis of FIG. 11.

FIG. 13 is a schematic view explaining the attachment of a movement member, the sensor base, and a detecting unit to the ink storing unit.

FIG. 14 is a schematic perspective view of the movement member.

FIG. 15 is a plan view of the movement member.

FIG. 16 is a bottom view of the movement member.

FIG. 17 is an enlarged view of a portion XVII of FIG. 12.

FIG. 18 is a schematic cross-sectional view explaining an initial operation and an ink detecting operation.

### DESCRIPTION OF EXEMPLARY EMBODIMENTS

Next, the embodiments of the invention will be described. The following embodiments are not limit the contents of the invention described in claims and all the configurations described in the present embodiment are not necessary for means to solve the invention.

### Principle of Invention

As a condition of the invention, at least two of the following three states need to be distinguished by the output of a piezoelectric element.

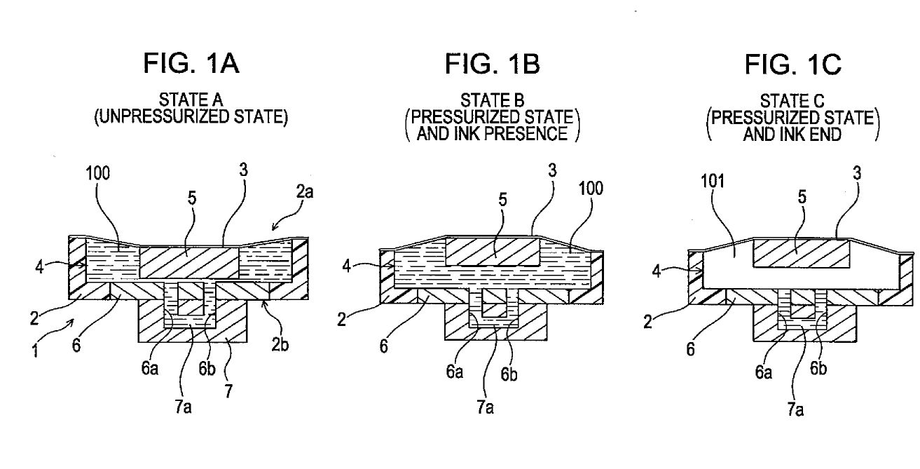

FIGS. 1A to 1C are views showing three states of main units of an ink detecting unit 1 as a detecting device. In FIGS. 1A to 1C, an upper opening 2a of an ink detecting unit casing 2 made of resin is sealed by a film 3 as a diaphragm. The inside of the ink detecting unit casing 2 closed by the film 3 is an ink storing unit 4 as a liquid storing unit. A movement member 5 is adhered to the film 3 and is displaced according to the internal pressure of the ink storing unit 4 together with the film 3. A sensor base 6 formed of SUS is provided in a lower opening 2b of the ink detecting unit casing 2 and a sensor chip 7 is provided on a lower surface of the sensor base 6 as a piezoelectric element. In the sensor base 6, two holes 6a and 6b communicating with the ink storing unit 4 are formed. In the sensor chip 7, a sensor cavity 7a communicating with the two holes 6a and 6b is formed. As shown in the black-painted-out state in FIGS. 1A to 1C, an ink 100 as a liquid is previously charged in the two holes 6a and 6b and the sensor cavity 7a. The ink 100 is charged in the ink storing unit 4 in FIGS. 1A and 1B and a pressurized fluid (for example, air) 101 is charged in the ink storing unit 4 in FIG. 1C instead of the ink 100.

The ink storing unit 4 shown in FIGS. 1A to 1C communicates with an upstream ink containing unit (not shown) and a downstream ink lead-out port (not shown). The ink pressurized in the upstream ink containing unit is charged in the ink storing unit 4 and is supplied to an ink consumption device such as a printer via the ink storing unit 4 and the ink lead-out port.

FIG. 1A shows a state A in which the movement member 5 is brought into contact with the sensor base 6 and the sensor cavity 7a is closed. FIGS. 1B and 1C show a state in which the movement member 5 is positioned above the sensor base 6 and the sensor cavity 7a is opened. FIG. 1A shows a state in which the upstream ink containing unit is not pressurized. In the state in which the upstream ink containing unit is not pressurized, the movement member 5 descends and comes into contact with the sensor base 6. This state A may be realized by the weight of the movement member 5 and the movement member 5 may be urged to the sensor base 6 by an urging member (not shown). If the liquid pressure of the ink storing unit 4 is not applied, the sensor cavity 7a becomes the closed space by the movement member 5.

The state A of FIG. 1A becomes an ink end state if the ink pack which deforms by external pressurizing force and discharges the ink is used as the ink containing unit like JP-A-2006-160371, but does not become the ink end state in the invention. If the ink of the ink pack is used up like JP-A-2006-160371, the volume of the ink pack substantially becomes 0 and no pressure is applied to the ink storing unit. As a result, the volume of the ink storing unit 4 is reduced, the film 3 is deformed, the movement member 5 descends together with the film 3, and the sensor cavity 7a becomes the closed space.

However, in the invention, the ink is the ink pack is not used, the pressurized fluid is introduced into the ink containing unit and the ink is forcedly fed. Accordingly, although the ink of the ink containing unit runs out, the pressurized fluid is introduced into the ink storing unit 4, that is, the fluid is introduced into the ink containing unit, so as to pressurize the inside of the ink containing unit, and the fluid is discharged to the ink storing unit. Thus, the state A of FIG. 1A is not obtained. In the invention, only in an unpressurized state in which the inside of the ink is not pressurized, the state A of FIG. 1A can be obtained.

The state B of FIG. 1B indicates the “ink presence” state in which the ink is forcedly fed from the ink containing unit of the pressurization upstream side of the ink containing unit. In this state B, the film 3 expands by the pressure of the ink, the movement member 5 is displaced upward together with the film 3, and the sensor cavity 7a communicates with the ink storing unit 4.

The state C of FIG. 1C indicates the “ink end” state in which the pressurized fluid (for example, air) 101 is forcedly fed from the upstream ink containing unit in which the ink is used up. In this state C, the film 3 expands by the pressure of the pressurized fluid (for example, air) 101 different from the ink, the movement member 5 is displaced upward together with the film 3, and the sensor cavity 7a communicates with the ink storing unit 4.

FIGS. 1B and 1C are similar to each other in the position of the movement member 5 and are different from each other in that a medium between the movement member 5 and the sensor base 6 is the ink (FIG. 1B or the pressurized fluid (FIG. 1C).

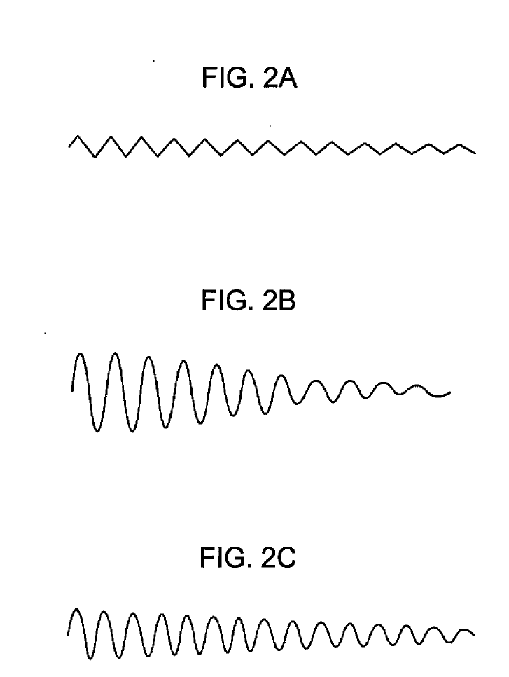

FIGS. 2A to 2C show the output waveforms of the piezoelectric element in the sensor chip 7 by the states of FIGS. 1A to 1C obtained by the experiments by the present inventor.

The characteristics of the output waveforms of FIGS. 2A to 2C are shown by the following Table.

| State | Frequency | Amplitude |
|---|---|---|
| State A | A1 kHz | AH (mV; substantially 0 mV) |
| State B | B1 (<A1) kHz | BH(>AH) (mV) |
| State C | C1 (≅A1) kHz | CH(AH < CH < BH) (mV) |

The characteristics shown in Table is exemplary and, if the movement member attached with a channel according to the below-described embodiment is used, the frequency may be reversed like frequency A1<frequency B1 or the amplitudes AH, BH and CH may be reversed by the change of the frequency of the excitation waveform to the piezoelectric element, and the states A to C can be distinguished by at least the amplitude (AH<CH<BH in the data of Table) of the free vibration. The states A to C can be discriminated by a combination of the amplitude and the frequency. That is, even when the frequencies A1 and C1 cannot be discriminated in the data of Table, the state A or the state C can be discriminated by comparing the amplitudes AH and CH.

### Description of Liquid Container

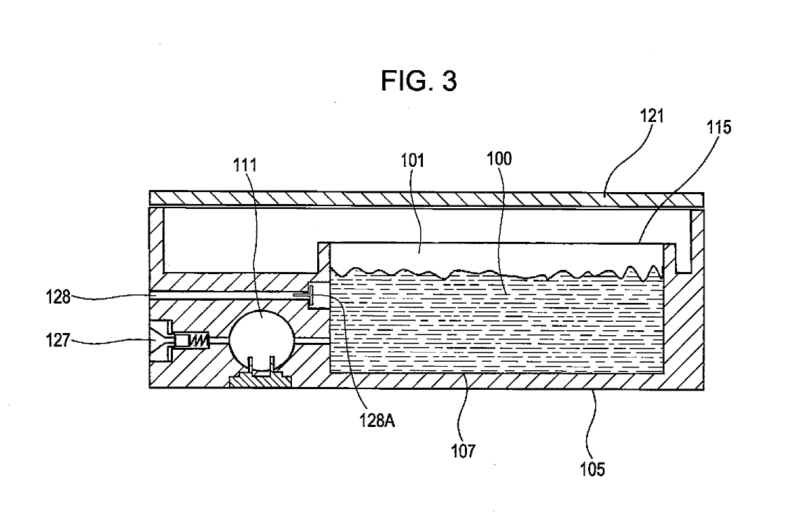

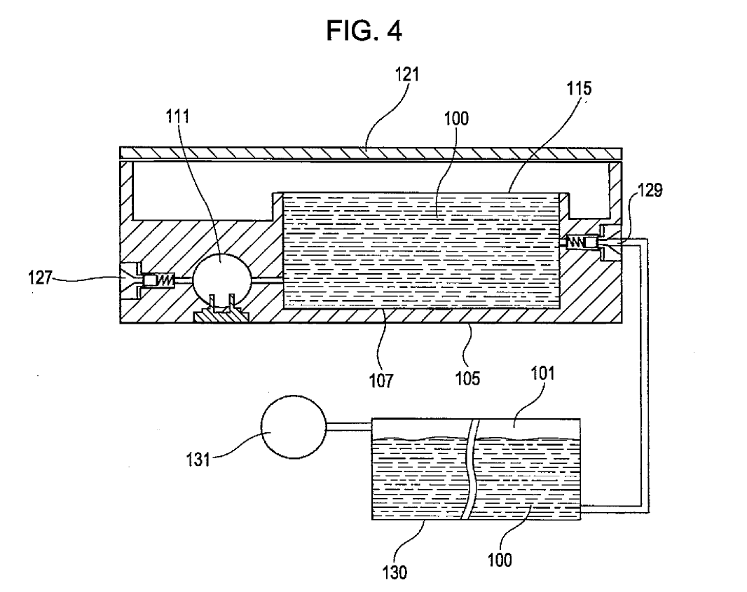

FIGS. 3 and 4 show two examples of a liquid container. As a common configuration of FIGS. 3 and 4, an ink containing unit 107 is provided in a casing main body 105 as a sub tank of the ink cartridge. An opening of one end of the ink containing unit 107 is sealed by a film 115, the ink containing unit 107 is made liquid-tight, and the evaporation of the received ink is prevented. The opening of one end of the casing main body 105 is closed by a cover 121. An ink lead-out port 127 is provided in the in containing unit 107 as a liquid outlet. An ink detecting unit 111 is provided between the ink lead-out port 127 and the ink containing unit 107 as a detecting device.

In the example of FIG. 3, a pressurized fluid inlet 128 communicating with the ink containing unit 107 (the pressurized fluid is the pressurization air in the present embodiment) is provided and a check valve 128A for preventing the ink from reversely flowing to a path to the pressurized fluid inlet 128 is provided.

In the example of FIG. 3, the pressurized fluid (for example, air) 101 is increased as the residual quantity of the ink 100 in the ink containing unit 107 is decreased, and only the pressurized fluid (for example, air) 101 is present in the ink containing unit 107 if the ink 100 runs out. Accordingly, in the ink detecting unit 111, the ink 100 is forcedly fed by the pressurized air when the ink is present in the ink containing unit 107, but the pressurized air is forcedly fed when the ink 100 runs out. In the example of FIG. 3, if the pressurized fluid is introduced, the air is introduced from the pressurized air inlet to the ink containing unit 107 such that the internal pressure of the ink containing unit 107 is increased, and the ink or air flows from the ink containing unit 107 toward the ink lead-out port 127 such that the internal pressure of the ink storing unit is increased. This state indicates the pressurization of the ink containing unit.

Accordingly, in the ink cartridge of FIG. 3, in the unpressurized state in which the pressurized air is not supplied to the pressurized fluid inlet 128, the state A of FIG. 1A is obtained and the ink detecting unit 111 detects the “unpressurized state” on the basis of the output signal of FIG. 2A. In the pressurized state in which the pressurized air is supplied to the pressurized fluid inlet 128, the state B of FIG. 1B is obtained and the ink detecting unit 111 detects the “pressurized state” and the “ink presence state” on the basis of the output signal of FIG. 2B if the ink is present in the ink containing unit 107. If the ink of the ink containing unit runs out in the pressurized state in which the pressurized air is supplied to the pressurized fluid inlet 128, the state C of FIG. 1C is obtained and the ink detecting unit 111 detects the “pressurized state” and the “ink end state” on the basis of the output signal of FIG. 2C.

In the example of FIG. 4, an ink entrance port 129 is provided instead of the pressurized fluid inlet 128 of FIG. 3. That is, the ink cartridge having the casing main body 105 is used as the sub tank and a main tank 130 is connected to the ink entrance port 129 of the sub tank. The pressurized fluid (for example, air) 101 is pressurized and supplied into the main tank 130 by a pressurization pump 131 and the ink 100 is supplied to the ink containing unit 107 via the ink entrance port 129 of the sub tank by the pressurized air. Accordingly, this case is different from the example of FIG. 3 in that the pressurized fluid is the ink from the main tank. In the example of FIG. 4, if the pressurized fluid is introduced, the air or ink is introduced from the pressurized air inlet 129 to the ink containing unit 107 such that the internal pressure of the ink containing unit 107 is increased and the ink or air flows from the ink containing unit 107 toward the ink lead-out port 127 such that the internal pressure of the ink storing unit is increased. This state indicates the pressurization of the ink containing unit.

In the example of FIG. 4, since the detection of the ink residual quantity of the sub tank is not important, the pressurized state or the unpressurized state is detected. That is, the state A of the unpressurized state of FIG. 1A is detected on the basis of the output signal of FIG. 2A and the state B of the pressurized state of FIG. 1B is detected on the basis of the output signal of FIG. 2B. In the ink end state in which the ink is not present in both the main tank 130 and the casing main body 105 as the sub tank of FIG. 4, the pressurized air of the main tank 130 is introduced into the ink detecting unit 111. Accordingly, this ink end state is equal to the state C of FIG. 1C and the ink end can be detected on the basis of the output signal of FIG. 2C.

### Summary of Liquid Consumption Device

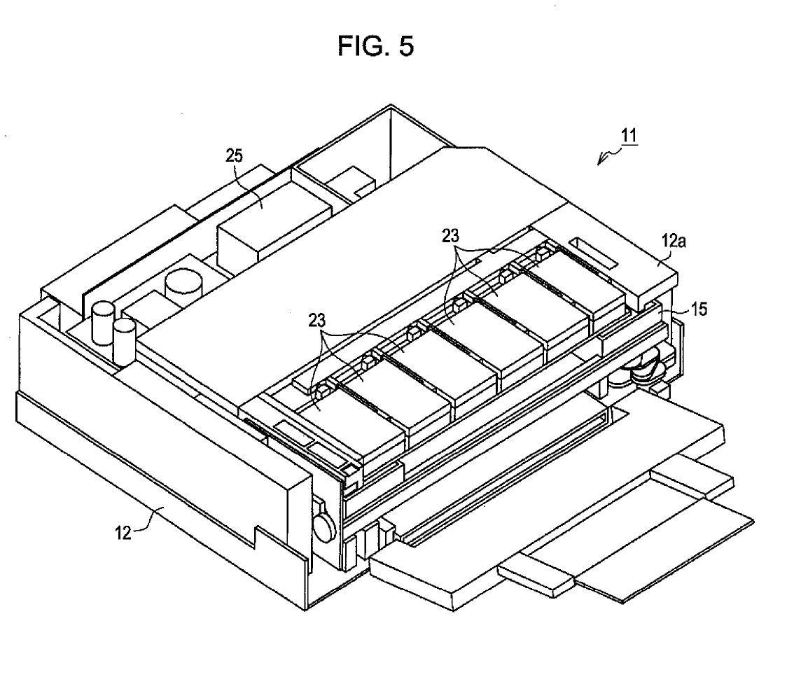

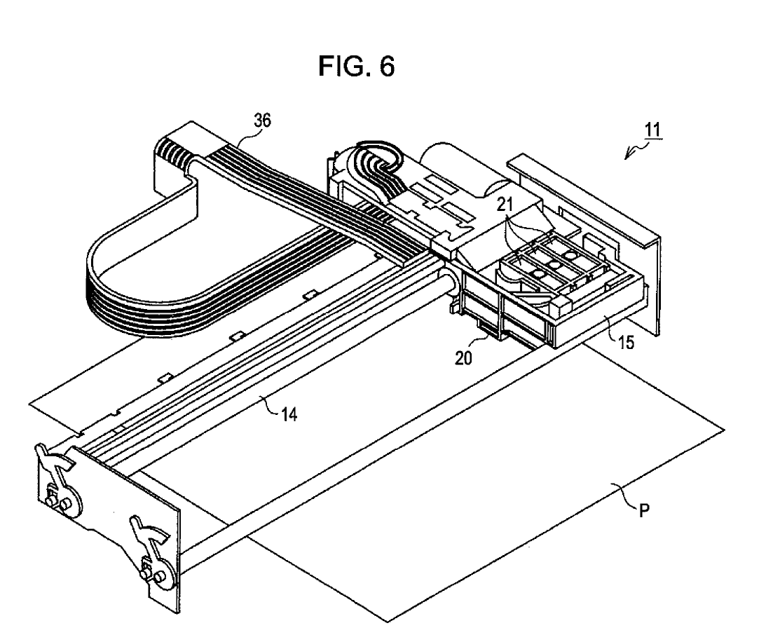

As shown in FIG. 5, a liquid consumption device according to the present embodiment or a printer 11 as a liquid consumption device is covered by a frame 12. As shown in FIG. 6, in the frame 12, a guide shaft 14, a carriage 15, a recording head 20 as a liquid ejection head, valve units 21, ink cartridges 23 (see FIG. 5) as a liquid storing body, and a pressurization pump 25 (see FIG. 5) are included.

As shown in FIG. 5, the frame 12 is a substantially rectangular parallelepiped box and has a cartridge holder 12a formed on the front surface thereof.

As shown in FIG. 6, the guide shaft 14 has a rod shape and is constructed in the frame 12. In the present embodiment, a direction in which the guide shaft 14 is constructed is called a main scan direction. The carriage 15 is inserted to be moved relative to the guide shaft 14 and is reciprocally moved in the main scan direction. The carriage 15 is connected to a carriage motor (not shown) via a timing belt (not shown). The carriage motor is supported by the frame 12, the carriage 15 is driven via the timing belt by driving the carriage motor, and the carriage 15 is reciprocally moved along the guide shaft 14, that is, in the main scan direction.

The recording head 20 which is provided on the lower surface of the carriage 15 includes a plurality of nozzles (not shown) for ejecting the ink as the liquid and discharges ink droplets onto a print medium such as recording paper so as to perform the recording of print data such as images or characters. The valve units 21 are mounted on the carriage 15 and the ink which is temporarily stored is supplied to the recording head 20 in a state in which the pressure is adjusted.

In the present embodiment, the valve units 21 can individually supply two inks per one valve unit to the recording head 20 in the state in which the pressure is adjusted. In the present embodiment, the total number of valve units 21 is three and the valve units correspond to six ink colors (black, yellow, magenta, cyan, light magenta, and light cyan).

A platen (not shown) is provided below the recording head 20 and this platen supports the recording medium as a target which is transported in a sub scan direction perpendicular to the main scan direction by a sheet transportation unit (not shown).

The ink cartridges 23 shown in FIG. 5 are detachably mounted in a cartridge mounting unit of an ink jet recording apparatus and supply the inks to the recording head (liquid ejection head) mounted in a recording apparatus. As the ink cartridges 23, any one of the ink cartridges shown in FIG. 3 or 4 is used. In the type of FIG. 3, the pressurization pump 25 shown in FIG. 5 is connected to the pressurized fluid inlet 128 of FIG. 3 and, in the type of FIG. 4, the pressurization pump shown in FIG. 5 is not used and an external pressurization pump is used.

### Detailed Example of Ink Detecting Unit

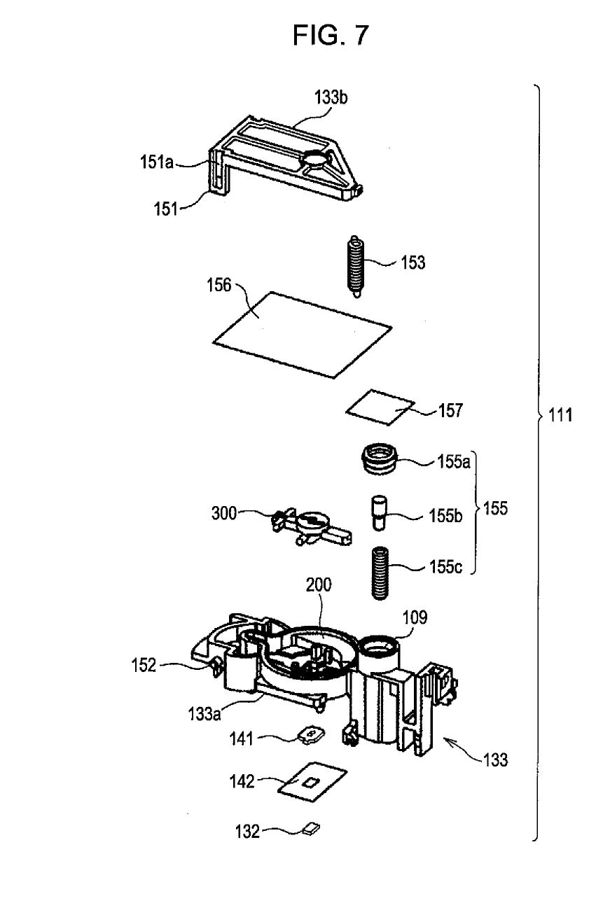

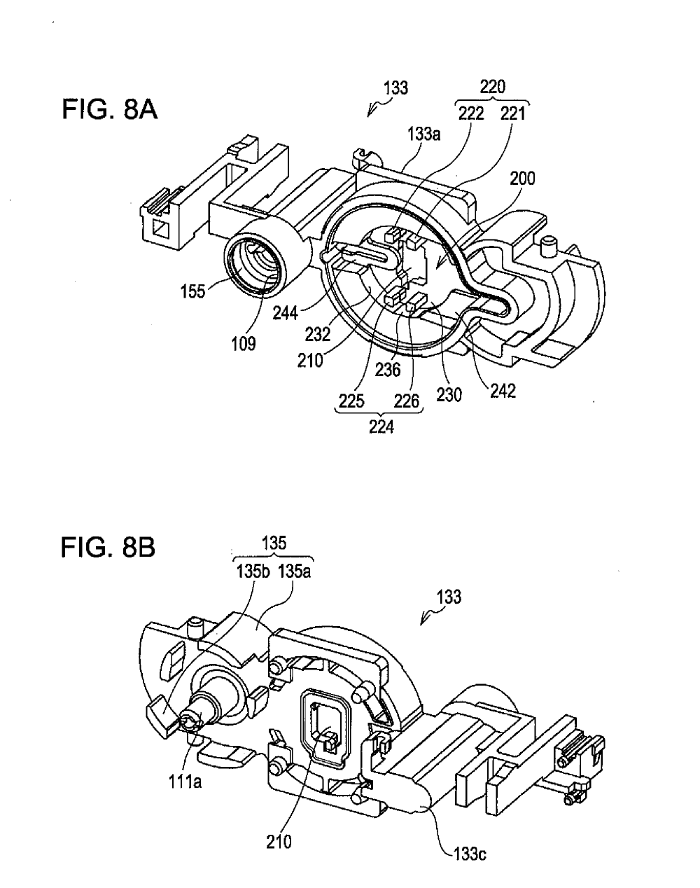

As shown in FIGS. 7, 8A and 8B, the ink detecting unit 111 of the present embodiment which can detect the three states of FIGS. 1A to 1C includes an ink detecting unit casing 133 made of resin and attached to the casing main body 105 of the ink cartridge by rotation, a sensor chip 132 (corresponding to the sensor chip 7 of FIGS. 1A to 1C) as a piezoelectric element fixed on a rear surface of the ink detecting unit casing 133 via a sensor base 141 as a detecting unit mounting member, and an insulating sensor sealing film 142 for covering the surface of the sensor base 141 surrounding the sensor chip 132.

The ink detecting unit casing 133 has an ink lead-out member 109 into which an ink supply needle (liquid lead-out needle) of a cartridge mounting portion is inserted. The ink lead-out member 109 corresponds to the ink lead-out port 127 of FIGS. 3 and 4. The ink detecting unit casing 133 includes an ink detecting unit casing main body 133a having an ink storing unit 200 as a liquid storing unit communicating with the ink lead-out member 109. The ink storing unit 200 corresponds to the ink storing unit 4 of FIGS. 1A to 1C. In the ink storing unit 200, a movement member 300 (corresponding to the movement member 5 of FIGS. 1A to 1C) shown in FIG. 7 is displaceably provided. In addition, a sealing film 156 (which is a diaphragm and corresponds to the film 3 of FIGS. 1A to 1C) as a diaphragm for partitioning the pressure chamber for detecting the residual quantity by sealing the opened surface of the ink storing unit 200 and a pressurizing member 133b for pressurizing (urging) the movement member 300 with the sealing film 156 interposed therebetween are provided.

The pressurizing member 133b fits an engagement shaft 152 protruding on the outer circumference of the ink detecting unit casing main body 133a into a hole 151a of a locking piece 151 protruding from a base end, is rotatably connected to the ink detecting unit casing main body 133a, and is fixed so as to pressurize (energize) the movement member 300 to the ink detecting unit casing main body 133a with the sealing film 156 interposed therebetween by connecting the front end thereof to the ink detecting unit casing main body 133a by a spring 153 as an urging member.

A channel opening/closing mechanism 155 for opening the channel when the ink supply needle of the cartridge mounting portion is inserted is mounted in the ink lead-out member 109. The channel opening/closing mechanism 155 includes a cylindrical seal member 155a fixed to the ink lead-out member 109, a valve body 155b for maintaining the channel in a closed state by seating the valve body in the seal member 155a, and a spring member 155c for urging the valve body 155b to be seated in the seal member 155a.

The opening of the ink lead-out member 109 in which the channel opening/closing mechanism 155 is mounted is sealed by the sealing film 157 (see FIG. 7). The sealing film 157 is welded into the opening cross section of the ink lead-out member 109 and the cross section of the seal member 155a mounted in the ink lead-out member 109.

When the ink cartridge 23 (see FIG. 5) is mounted in the cartridge mounting portion of the recording apparatus, the ink supply needle of the cartridge mounting portion penetrates the sealing film 157 and is inserted into the ink lead-out member 109. At this time, the ink supply needle inserted into the ink lead-out member 109 separates the valve body 155b from the seal member 155a such that the channel of the ink detecting unit casing 133 communicates with the ink supply needle and the ink is supplied to the recording apparatus.

As shown in FIG. 8B, the ink detecting unit casing main body 133a has a container engagement portion 135 which is rotatably engaged with an attachment portion of the casing main body 105 at the rear surface thereof. A connection needle 111a inserted into the ink lead-out member (not shown) of the ink containing unit 107 of FIG. 3 or 4 is provided inside the container engagement portion 135. The connection needle 111a penetrates the sealing film and is inserted into the ink lead-out member of the ink containing unit 107. Accordingly, a valve mechanism in the ink lead-out member is opened such that the ink is led out.

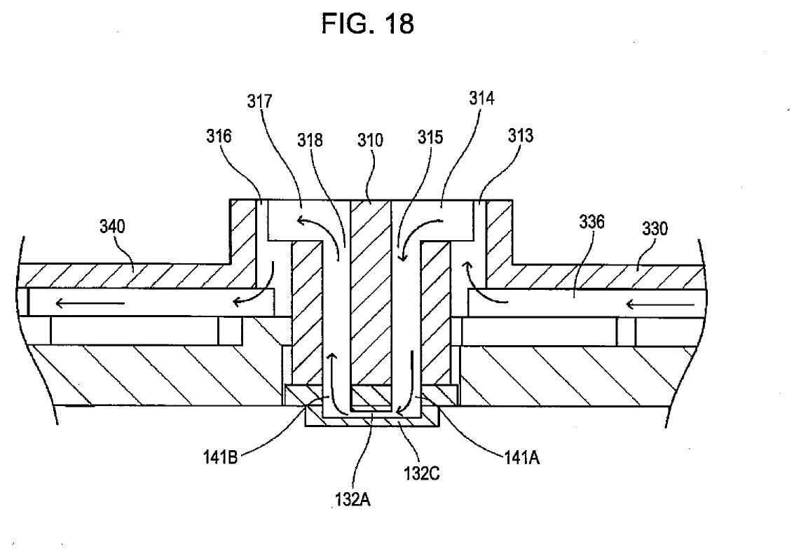

The sensor chip 132 is a piezoelectric detecting unit fixed to the rear surface of the ink detecting unit casing main body 133a such that vibration is applied to the sensor cavity 132A as a detecting space described in FIGS. 10 and 18, and outputs a variation in free vibration (residual vibration) due to a variation in ink flow rate (pressure) as an electric signal. The output signal of the sensor chip 132 is analyzed by a control circuit of the recording apparatus and the ink residual quantity of the ink containing unit 107 of FIG. 3 or 4 is detected.

### Detecting Unit

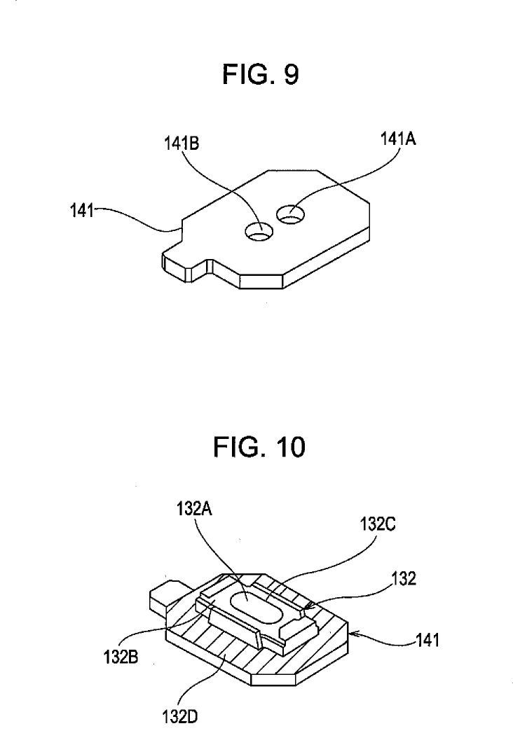

FIG. 9 is a perspective view of a sensor base 141 (corresponding to the sensor base 6 of FIGS. 1A to 1C) when viewed from the lower side. As shown in FIG. 9, in the sensor base 141, a first through-hole 141A as a supply path penetrating in a thickness direction and a second through-hole 141B as a discharge path are provided. The sensor base 141 is formed of, for example, SUS.

FIG. 10 is a perspective view of the sensor base 141 in which the sensor chip 132 is mounted when viewed from the upper side. In FIG. 10, the sensor chip 132 has a sensor cavity 132A (which is provided below a vibration plate 132B and a piezoelectric element 132C in FIG. 10 and corresponds to the sensor cavity 7a of FIGS. 1A to 1C) as a detecting space for receiving the ink (liquid) to be detected and the sensor cavity 132A communicates with the first through-hole 141A and the second through-hole 141B of the sensor base 141. The upper surface of the sensor cavity 132A is closed by the vibration plate 132B. The piezoelectric element 132C is provided on the upper surface of the vibration plate 132B.

The piezoelectric element 132C applies the vibration to the sensor cavity 132A so as to output a residual vibration waveform due to the vibration. The printer can detect the output signal and determine the ink end. As the material of the piezoelectric layer, zirconate titanate (PZT), lead lanthanum zirconate titanate (PLZT), a piezoelectric film without lead or the like may be used.

The sensor chip 132 is integrally adhered to the sensor base 141 by an adhesive layer 132D by seating the lower surface of the chip main body on the central portion of the upper surface of the sensor base 141 and the sensor base 141 and the sensor chip 132 are simultaneously sealed by the adhesive layer 132D.

### Ink Storing Unit and Movement Member

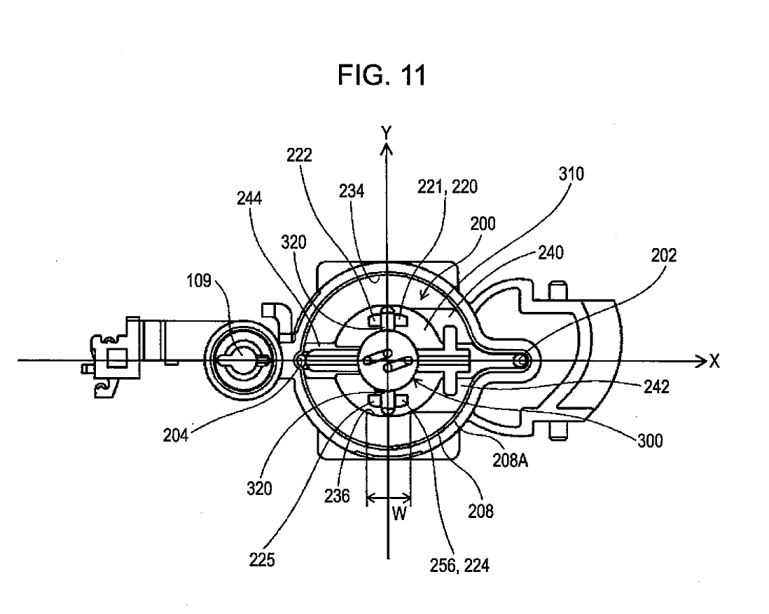

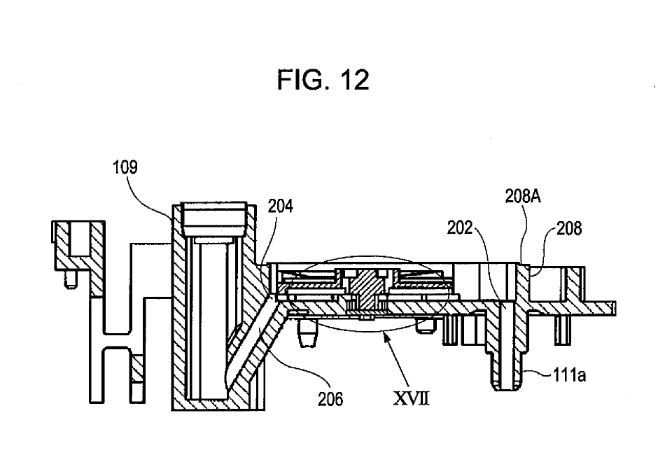

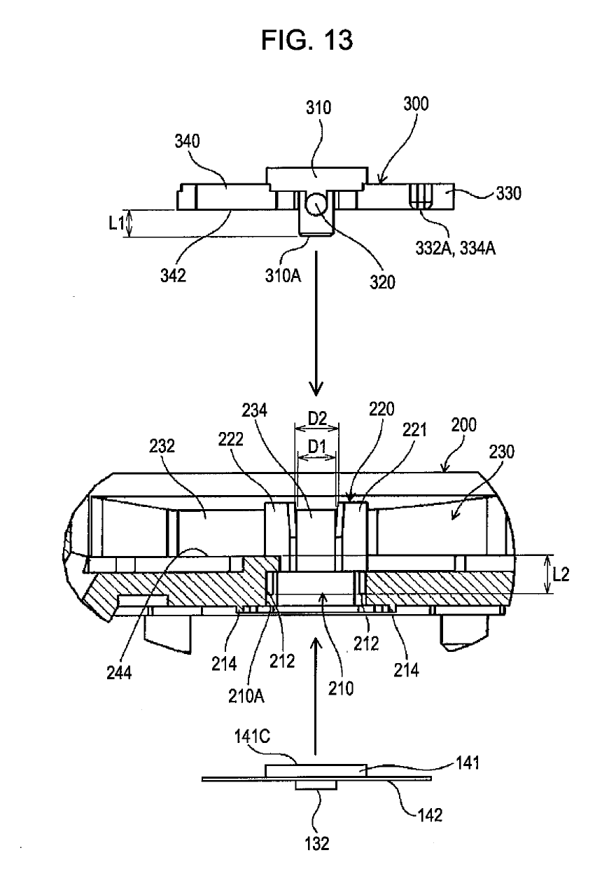

FIG. 11 is a plan view showing a state in which the movement member 300 is arranged in the ink storing unit 200. FIG. 12 is a cross-sectional view taken along an X-axis direction of FIG. 11, and FIG. 13 is a view showing the movement member 300 and the sensor chip 132 as the piezoelectric element arranged in the ink storing unit 200.

In the ink storing unit 200, an ink inlet 202 as a liquid inlet and an ink outlet 204 as a liquid outlet are formed. The ink inlet 202 communicates with the connection needle 111a shown in FIG. 12. As shown in FIG. 12, the ink outlet 204 communicates with the ink lead-out member 109 via an inclined channel 206.

In the cross section of a peripheral wall 208 partitioning the ink storing unit 200, a welding rib 208A is formed. The sealing film 156 (see FIG. 7) as a flexible diaphragm is welded into the welding rib 208A. The ink storing unit 200 closed by the sealing film 156 as the diaphragm forms a pressure chamber and the sealing film 156 as the diaphragm is displaced according to the ink pressure or the pressurized fluid pressure between the ink inlet 202 and the ink outlet 204.

In the central portion of the ink storing unit 200, an opening 210 facing the sensor base 141 shown in FIG. 13 is formed. As shown in FIG. 13, the movement member 300 and the sensor base 141 for fixing the sensor chip 132 as the piezoelectric element are provided so as to face the opening 210. A lower end surface 310A of a pressure-receiving plate 310 shown in FIG. 13 which faces a sensor cavity seal surface 141c as a detecting space seal surface of the sensor base 141 is called a sensor cavity seal surface 310A as the detecting space seal surface.

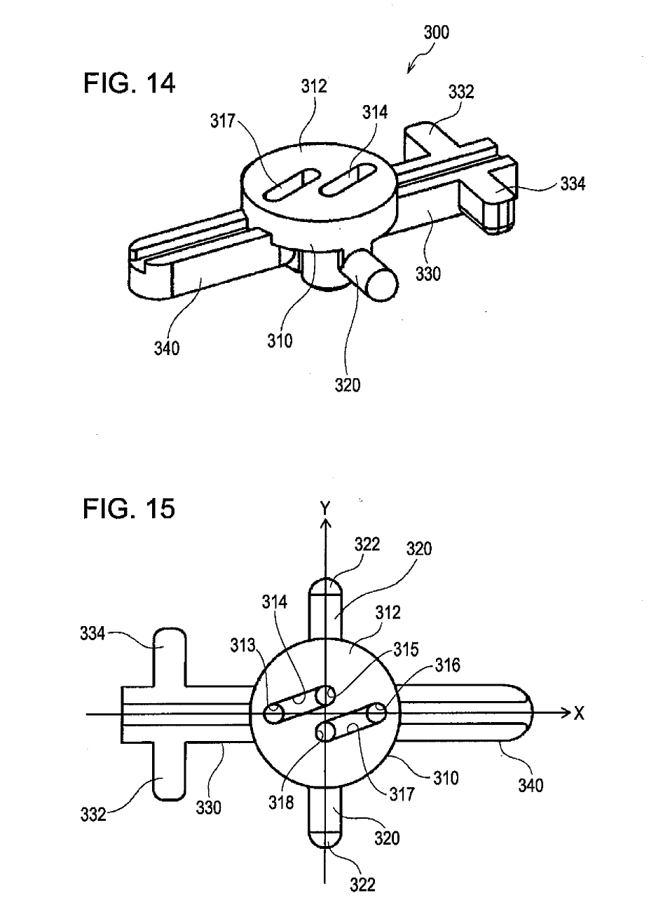

FIGS. 14 to 16 are a perspective view, a plan view and a bottom view of the movement member 300, respectively. The movement member 300 includes the pressure-receiving plate 310. An upper end surface 312 of the pressure-receiving plate 310 is welded into the sealing film 156 as the diaphragm.

Directions along the orthogonal two axes having an intersection at the center of the ink storing unit 200 (the center of the circular pressure-receiving plate 31) are defined an X direction (first direction) and a Y direction (second direction).

In the movement member 300, two shafts 320 and 320 extending from the pressure-receiving plate 310 toward the both ends of the Y direction of FIG. 15 are provided. The front end of each of the shafts 320 has a curved shape, for example, a semi-spherical surface 322. An upstream member 330 and a downstream member 340 extending from the pressure-receiving plate 310 to the both ends of the X direction of FIG. 15 are provided.

The upstream member 330 has protrusion members 332 and 334 protruding in the direction parallel with the Y direction in FIG. 15. The rear surface of the protrusion member 332 becomes a first height reference surface 332A and the rear surface of the protrusion member 334 becomes a second height reference surface 334A.

The upstream member 330 has a first groove channel 336 as a first channel communicating with an end opening 336A of the X direction and extending in the X direction. The inner end of the first groove channel 336 communicates with a first through-hole 313 as the first channel formed in the pressure-receiving plate 310. A second groove channel 314 as the first channel is formed in the upper end surface 312 of the pressure-receiving plate 310, and the first through-hole 313 and a second through-hole 315 as the first channel are formed in the pressure-receiving plate 310 toward the second groove channel 314. The second groove channel 314 extends perpendicular to the X and Y directions, the first through-hole 313 existing on the X axis and the second through-hole 315 existing on the Y axis communicate with each other.

A third height reference surface 342 of the rear surface of the downstream member 340 functions as the first seal surface and the third height reference surface.

The downstream member 340 has a third groove channel 344 as a second channel formed in the third height reference surface 342 as the first seal surface. The inner end of the third groove channel 344 communicates with a third through-hole 316 as the second channel formed in the pressure-receiving plate 310. In addition, a fourth groove channel 317 as the second channel is formed in the upper end surface 312 of the pressure-receiving plate 310, and the third through-hole 316 and a fourth through-hole 318 as the second channel are formed in the pressure-receiving plate 310 so as to face the fourth groove channel 317. The fourth groove channel 317 extends perpendicular to the X and Y directions, and the third through-hole 316 existing on the X axis and the fourth through-hole 318 existing on the Y axis communicate with each other.

Since the upper end surface 312 of the pressure-receiving plate 310 is welded into the sealing film 156 as the diaphragm, the second groove channel 314 and the fourth groove channel 317 are sealed in a liquid-tight manner by the sealing film 156 as the diaphragm. As shown in FIGS. 14 and 15, the grooves are formed in the upper end surfaces of the upstream member 330 and the downstream member 340 in order to prevent the shrinkage at the time of injection molding.

The first groove channel 336, the second groove channel 314, the first through-hole 313, and the second through-hole 315 formed in the upstream member 330 and the pressure-receiving plate 310 are collectively called the first channel. Similarly, the third groove channel 344, the fourth groove channel 317, the third through-hole 316 and the fourth through-hole 318 formed in the downstream member 340 and the pressure-receiving plate 310 are collectively called the second channel. The first channel communicates with the first through-through 141A as a supply path formed in the sensor base 141 shown in FIG. 9 and the second channel communicates with the second through-hole 141b as a discharge path formed in the sensor base 141 shown in FIG. 9. In this state, since the third height reference surface 342 as the first seal surface is in contact with the second seal surface 244 of the ink storing unit 200, the third groove channel 344 functions as a conduit connected to the ink outlet 204. Thus, the ink is sucked from the ink lead-out port 127, the ink flows from the first through-hole 313.

In an initial stage in which the ink is introduced into the ink storing unit 200, the first channel and the second channel are formed and the ink flows in the first channel, the first through-hole 141A, the sensor cavity 132A (see FIG. 10), the second through-hole 141B and the second channel by the suction from the ink lead-out port and a capillary phenomenon and the ink is filled in the sensor cavity 132A. Accordingly, the movement member 300 may be also called a channel forming member. Even in any state of the FIGS. 1A to 1C, the ink is charged in at least the sensor cavity 7a and air can be prevented from being introduced and erroneous detection can be prevented.

### Positioning of Movement Member

The positioning structure of the movement member 300 will be described with reference to FIG. 11. In FIG. 11, the intersection of the orthogonal two axes in the X and Y directions is equal to the central position of the ink storing unit 200. As shown in FIG. 11, in the ink storing unit 200, a first bearing 220 and a second bearing 224 for positioning two shafts 320 and 320 of the pressure-receiving plate 310 are provided (see FIG. 8A). The first bearing 220 having two erected members 221 and 222 which are erected on the both sides of one shaft 320 from the ink storing unit 200. The second bearing 224 has two erected members 225 and 226 which are erected on the both sides of the other shaft 320 from the ink storing unit 200.

FIG. 13 shows, for example, the first bearing 220. A gap between the two erected members 221 and 222 is formed such that a dimension D1 indicating the gap of a base end is smaller than a dimension D2 indicating the gap of a free end (dimension D1<dimension D2). The second bearing 224 has the same dimension as the first bearing 220.

The diameter of the shaft 320 of the pressure-receiving plate 310 is slightly smaller than the dimension D1. Accordingly, the positioning of the movement member 300 in the X direction shown in FIG. 11 is performed by the two shafts 320 of the pressure-receiving plate 310 and the first bearing 220 and the second bearing 224 for receiving the shafts.

In order to position the movement member 300 in the Y direction, facing members 234 and 236 facing the semi-spherical surfaces 322 which are front ends of the two shafts 320 protruding from the pressure-receiving plate 310 are provided in the ink storing unit 200. In the ink storing unit 200, as shown in FIG. 8A, a concave portion 230 for receiving the movement member 300 is formed. The facing members 234 and 236 are formed portions of the inner side surface 232 which forms the concave portion.

The inner side surface 232 is the peripheral surface and the facing members 234 and 236 formed in the portions thereof are formed of the flat surfaces having a predetermined width W in the X direction of FIG. 11.

Since the facing members 234 and 236 have the width W and are the flat surfaces, the distance between the two facing members 234 and 236 is constant. If there is a slight difference between the dimension D1 in the minimum gap between the first bearing 220 and the second bearing 224 and the diameter of the shaft 320, the movement member 300 is displaced in the X direction. However, within the range of the width W, the deviation in the Y direction is in a predetermined range.

Since the semi-spherical surfaces 322 which are the front ends of the two shafts 320 have the curved shape, for example, the semi-spherical surface, the semi-spherical surfaces are in point contact with the facing members 234 and 236. Accordingly, although the movement member 300 is displaced while the semi-spherical surfaces 322 which are the front ends of the two shafts 320 of the pressure-receiving plate in contact with the facing members 324 and 326, friction resistance is significantly low. Thus, the movement member 300 is not prevented from being displaced according to the ink pressure or the pressurized fluid pressure in the ink storing unit 200.

The center of the movement member 300 is positioned so as to be substantially equal to the intersection of the orthogonal two axes X and Y, which is the center of the ink storing unit 200. Accordingly, the positional precision of the movement member 300 relative to the ink storing unit 200 is improved. The improvement of the positional precision is very important in the charging of the ink in the sensor cavity 132A in an initial stage in which the ink is introduced into the ink storing unit 200 and that reason will be described later.

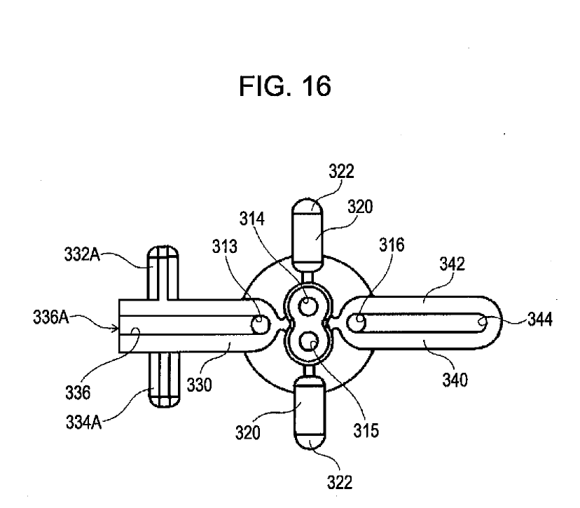

Next, the positioning of the height direction of the movement member 300 will be described. As described above, as shown in FIGS. 13 and 16, the upstream member 330 of the movement member 300 has protrusion members 332 and 334, the rear surface portion of the protrusion member 332 becomes the first height reference surface 332A, and the rear surface portion of the protrusion member 334 becomes the second height reference surface 334A. The third height reference surface 342 of the rear surface portion of the downstream member 340 of the movement member 300 functions as the first seal surface and the third height reference surface.

As shown in FIGS. 8 and 11, the ink storing unit 200 has the first height reference surface 332A as the first seal surface of the movement member 300, the second height reference surface 334A as the first seal surface, the first height reference surface 240 as the second seal surface which is in contact with the third height reference surface 342 as the first seal surface, the second height reference surface 242 as the second seal surface and the third height reference surface 244 as the second seal surface. The height position of the movement member 300 may be stably set to be in contact with three points, that is, the first height reference surface 240, the second height reference surface 242 and the third height reference surface 244.

The third height reference surface 342 of the rear surface portion of the downstream member 340 of the movement member 300 functions as the first seal surface and is in contact with the third height reference surface of the ink storing unit 200 and the second seal surface at the initial stage in which the ink is introduced into the ink storing unit 200. Accordingly, the fourth groove channel 317 of the downstream member 340 of the movement member 300 is sealed. The sealing of the fourth groove channel 317 of the downstream member 340 is very important in the charging of the ink in the sensor cavity 132A by the suction from the ink lead-out port 127 and the capillary phenomenon in the initial stage. That reason is because, if the seal property of the first height reference surface 332A, the second height reference surface 334A and the third height reference surface 342 forming the first seal surface, and the first height reference surface 240, the second height reference surface 242 and the third height reference surface 244 forming the second seal surface is bad, the conduit function at the time of the suction from the ink lead-out port 127 and the capillary phenomenon deteriorates and thus the ink flows in the channel other than the first channel and the second channel of the movement member 300. If the ink is separated from the channel, the movement member 300 is displaced together with the sealing film 156 as the diaphragm and thus the first height reference surface 332A, the second height reference surface 334A and the third height reference surface 342 forming the first seal surface, and the first height reference surface 240, the second height reference surface 242 and the third height reference surface 244 forming the second seal surface are not in contact with each other. In the initial stage, the first height reference surface 332A, the second height reference surface 334A and the third height reference surface 342 forming the first seal surface, and the first height reference surface 240, the second height reference surface 242 and the third height reference surface 244 forming the second seal surface are not in contact with each other. Then, the ink is not charged in the sensor cavity 132A such that the ink residual quantity cannot be detected.

The improvement of the positional precision of the movement member 300 relative to the ink storing unit 200 is very important in the charging of the ink in the sensor cavity 132A in the initial stage in which the ink is introduced into the ink storing unit 200 and is realized in the present embodiment. Accordingly, in the states A to C of FIGS. 1A to 1C, since the ink is always charged in the sensor cavity 7a, the erroneous detection of the states can be suppressed.

The first height reference surface 332A, the second height reference surface 334A and the third height reference surface 342 forming the first seal surface, and the first height reference surface 240, the second height reference surface 242 and the third height reference surface 244 forming the second seal surface may also called an air bubble discharging seal surface. That is, if the first height reference surface 332A, the second height reference surface 334A and the third height reference surface 342 forming the first seal surface, and the first height reference surface 240, the second height reference surface 242 and the third height reference surface 244 forming the second seal surface are sealed with certainty, it is possible to facilitate the removal of the air bubbles remaining in the sensor cavity 132A by the suction from the ink lead-out port 127 and the capillary phenomenon.

At the time of the detection of the liquid and the initial stage, the seal load which is in contact with the first height reference surface 332A, the second height reference surface 334A and the third height reference surface 342 forming the first seal surface, and the first height reference surface 240, the second height reference surface 242 and the third height reference surface 244 forming the second seal surface can be ensured by only the urging force of the spring 153 as the urging member shown in FIG. 7. Then, in the initial stage, external force other than the spring 153 as the urging member does not need to be applied.

### Positioning of Sensor Base and Detecting Unit

Next, the positioning of the sensor base 141 shown in FIG. 10 and the sensor chip 132 as the piezoelectric element mounted therein will be described.

As described above, the ink storing unit 200 as the liquid storing unit has the opening 210 for exposing one surface of the sensor base 141. The opening 210 has three contact surfaces 212 which are in contact with one surface of the sensor base 141. If one surface of the sensor base 141 is in contact with the contact surfaces 212, the attachment heights of the sensor base 141 and the sensor chip 132 are positioned.

The opening 210 of the ink storing unit 200 as the liquid storing unit has an inner peripheral wall 210A having a shape corresponding to the outer appearance of the sensor base 141. A welding margin 214 welded with the sensor sealing film 142 is formed in the periphery of the opening 210.

The sensor base 141 inserted into the opening 210 is brought into contact with the contact surfaces 212 of the opening 210 of the ink storing unit 200 such that the height thereof is positioned and the two-dimensional planar position thereof is positioned by the inner peripheral wall 210A. Since the intersection of the orthogonal two axes X and Y is set in the center of the opening 210, the center of the sensor chip 132 mounted in the sensor base 141 is set to the intersection of the orthogonal two axes X and Y.

In FIG. 13, in the pressure-receiving plate 310, the distance from the first height reference surface 332A, the second height reference surface 334A and the third height reference surface 342 forming the first seal surface to the sensor cavity seal surface 310A as the detecting space seal surface is L1. In the ink storing unit 200, the distance from the first height reference surface 240, the second height reference surface 242 and the third height reference surface 244 forming the second seal surface to the contact surfaces is L2. At this time, the following Equation (1) is satisfied.

L1>L2 (1)

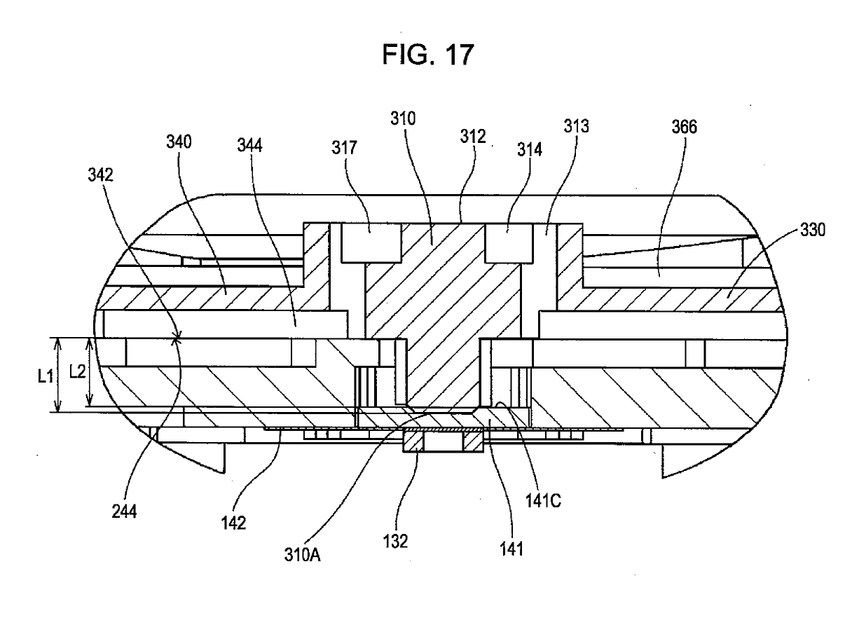

The meaning of Equation (1) will be described with reference to FIG. 17 which is the enlarged view of a portion XVII of FIG. 12. In FIG. 17, L1>L2 indicates that the sensor cavity seal surface 310A of the pressure-receiving plate 310 overlaps with the lower side of the sensor cavity seal surface 141C of the sensor base 141. Actually, as shown in FIG. 17, the pressure-receiving plate 310 does not overlap with the sensor base 141, the sensor base 141 is bent downward by the overlap by the flexibility of the sensor sealing film 142, and the sensor cavity seal surface 310A of the pressure-receiving plate 310 is brought into contact with the sensor cavity seal surface 141C of the sensor base 141 with certainty.

The distances L1 and L2 will be described in more detail. When the design reference value of the distance L1 and L2 is L0 and a maximum value of a positive variation of the distance L1 is L01, L0<L1<L0+L01 is obtained and, when a maximum value of a negative variation of the distance L2 is −L02, L0−L02<L2<L0 is obtained. Here, L02<L01.

In this case, Equation (2) is satisfied.

L02<L1−L2<L01 (2)

If Equation (2) is satisfied, Equation (1) is necessarily satisfied. A difference between the distance L1 and the distance L2 is between an absolute value |L2| of the maximum value of the negative variation of the distance L2 and an absolute value |L1| of the maximum value of the positive variation of the distance L1.

### Operation of Initial Stage and Liquid Detection

In the initial stage in which the ink is introduced into the ink storing unit 200, the movement member 300 is displaced by the urging force of the spring 153 as the urging member, the sensor cavity seal surface 310A of the pressure-receiving plate 310 is brought into the sensor cavity seal surface 141C of the sensor base 141, and the sealing film 156 as the diaphragm is displaced at a position where the volume of the ink storing unit 200 is reduced. This state is shown in FIG. 18. If the introduction of the ink into the ink storing unit 200 is started, as shown in FIG. 18, the flow of the first channel and the second channel is realized and the ink is charged in the sensor cavity 132A. If air bubbles are generated in the sensor cavity 132A, the air bubbles are discharged by the second channel of the downstream side. Thus, in the states of FIGS. 1A to 1C, it is possible to prevent the air bubbles from being generated in the sensor cavity 7a and prevent erroneous detection.

In the pressurized state, unlike FIG. 18, the ink pressure or the pressurized fluid pressure of the ink storing unit 200 is large. Accordingly, the sealing film 156 as the diaphragm is expanded, the volume of the ink storing unit 200 is increased, and the pressure-receiving plate 310 is separated from the sensor cavity seal surface 141C of the sensor base 141 against the urging force of the spring 153 as the urging member (the state of FIG. 1B or FIG. 1C). In the unpressurized state in which the ink pressure is less than a predetermined value, the movement member 300 is displaced by the urging force of the spring 153 as the urging member, the pressure-receiving plate 310 is brought into contact with the sensor cavity seal surface 141C of the sensor base 141, and the sealing film 156 as the diaphragm is displaced at a position where the volume of the liquid detecting chamber is reduced, similar to FIG. 18 (the state of FIG. 1A).

As described above, although the present embodiment is described in detail, it will be apparent to those skilled in the art that the invention may be modified without departing from the new matter and effect of the invention. Accordingly, all modifications are included in the scope of the invention. For example, in the specification or drawing, the terms described together with other terms having the wider meaning or the same meaning may be replaced with the other terms in any one of the specification or the drawing.

The liquid detection is performed in order to perform the detection of the liquid pressure in addition to the detection of the liquid residual quantity.

That is, the liquid detecting unit is not limited to the piezoelectric detecting unit. If the displacement of the movement member 300 displaced by the liquid pressure can be detected, for example, an optical detecting unit may be used.

The use of the liquid storing container of the invention is not limited to the ink cartridge of the ink jet recording apparatus. The liquid storing container may be used in various liquid consumption apparatus having a liquid ejecting head for discharging a small quantity of liquid droplets.

The detailed examples of the liquid consumption apparatus include, for example, an apparatus including a coloring material ejecting head used for manufacturing color filters of a liquid crystal display, an apparatus including an electrode material (conductive paste) ejecting head used for forming electrodes of an organic EL display or a field emission display (FED), an apparatus including a bio organic material ejecting head used for manufacturing bio chips, and an apparatus including a sample ejecting head as a precise pipette, a printing apparatus and a micro-dispenser.

In the invention, the liquid is a material which can be ejected by a liquid consumption apparatus. A representative example of the liquid is the ink in the above-described embodiment. The liquid may be a material other than a material used for printing characters or images In the invention, the liquid may be a liquid or a liquid mixed with solid materials such as pigments or metal particles.

The entire disclosure of Japanese Patent Application Nos. 2007-274739, filed Oct. 23, 2007 and 2008-219263, filed Aug. 8, 2008 are expressly incorporated by reference herein.

What is claimed is:

1. A liquid storing container comprising:
a liquid containing unit which discharges a liquid by introducing a pressurized fluid into a region, in which the liquid is stored;
a liquid lead-out port which supplies the liquid from the liquid containing unit to a liquid consumption device; and
a detecting device which is provided between the liquid containing unit and the liquid lead-out port,
wherein the detecting device includes:
a liquid storing unit which is provided between the liquid containing unit and the liquid lead-out port;
a piezoelectric element which applies vibration to a sensor cavity for storing the liquid in communication with the liquid storing unit and detects a state of free vibration due to the vibration; and
a movement member which is displaced according to a pressurized state of the liquid storing unit at a position facing the sensor cavity.

2. The liquid storing container according to claim 1, wherein:
the pressurized fluid is not a liquid, and
the piezoelectric element outputs different signals depending on whether a medium between the sensor cavity and the movement member is the liquid supplied from the liquid containing unit or the pressurized fluid, at the time of introducing the pressurized fluid into the region

3. The liquid storing container according to claim 2, wherein the piezoelectric element outputs different frequencies of the free vibration depending on whether the medium between the sensor cavity and the movement member is the liquid or the pressurized fluid.

4. The liquid storing container according to claim 2, wherein the piezoelectric element outputs different amplitudes of the free vibration depending on whether the medium between the sensor cavity and the movement member is the liquid or the pressurized fluid.

5. The liquid storing container according to claim 2, wherein:
one surface of the movement member closes the sensor cavity at the time of unpressurizing inside of the liquid containing unit, and
the piezoelectric element outputs the different signals at the time of pressuring and unpressurizing inside of the liquid containing unit.

6. The liquid storing container according to claim 5, wherein the piezoelectric element outputs different amplitudes of the free vibration at the time of pressurizing and unpressurizing inside of the liquid containing unit.

7. The liquid storing container according to claim 5, wherein the pressurization and the unpressurization of inside of the liquid containing unit is detected on the basis of a combination of the frequencies and amplitudes of the free vibration output from the piezoelectric element.

8. The liquid storing container according to claim 2, wherein the pressurized fluid is air.

9. The liquid storing container according to claim 1, wherein:
the pressurized fluid is the liquid,
one surface of the movement member closes the sensor cavity, and
the piezoelectric element outputs different signals at the time of pressurizing and unpressurizing inside of the liquid containing unit.

10. The liquid storing container according to claim 9, wherein the piezoelectric element outputs different amplitudes of the free vibration at the time of pressurizing and unpressurizing inside of the liquid containing unit.

11. The liquid storing container according to claim 9, wherein the pressurization and the unpressurization of inside of the liquid containing unit is detected on the basis of a combination of the frequency of the free vibration and the amplitude output from the piezoelectric element.

12. The liquid storing container according to claim 1, wherein the liquid storing unit is configured by sealing an opening formed in the upper surface thereof by a film which is deformable according to the pressurized state, and the piezoelectric element is disposed below the liquid storing unit.

13. The liquid storing container according to claim 12, wherein the movement member is moved by the deformation of the film according to a variation in the pressurized state of the liquid storing unit.

14. The liquid storing container according to claim 13, wherein the movement member is adhered to the film.

15. The liquid storing container according to claim 14, wherein the movement member is urged by an urging member in a direction in which the piezoelectric element is disposed.

16. A liquid storing container comprising:
a liquid containing unit which is storing the liquid and discharges the liquid by introducing a fluid inside;
a liquid lead-out port which supplies the liquid from the liquid containing unit to a liquid consumption device; and
a detecting device which is provided between the liquid containing unit and the liquid lead-out port,
wherein the detecting device includes:
a liquid storing unit which is provided between the liquid containing unit and the liquid lead-out port;
a piezoelectric element which applies vibration to a sensor cavity for receiving the liquid in communication with the liquid storing unit and detects a state of free vibration due to the vibration; and
a movement member which is displaced according to a pressurized state of the liquid storing unit at a position facing the sensor cavity.

17. The liquid storing container according to claim 16, wherein the piezoelectric element outputs different signals depending on whether a medium between the sensor cavity and the movement member is the liquid or the pressurized fluid, when the fluid is introduced into the liquid containing unit.

18. The liquid storing container according to claim 16, wherein the piezoelectric element outputs different frequencies or amplitudes of the free vibration depending on whether the medium between the sensor cavity and the movement member is the liquid or the pressurized fluid.

19. The liquid storing container according to claim 16, wherein the piezoelectric element outputs different frequencies or amplitudes of the free vibration when the fluid is introduced and is not introduced.

20. The liquid storing container according to claim 16, wherein the liquid containing unit includes a main tank and a sub tank and the fluid is introduced into the sub tank via the main tank.
